(19) United States
(12) Patent Application Publication
(10) Pub. No.: US 2025/0275835 A1
(43) Pub. Date: Sep. 4, 2025

(54) Modelling Protocol for Root Analogue Dental Implants

(71) Applicant: University of Manitoba, Winnipeg (CA)

(72) Inventors: Anastasia Matsko, Winnipeg (CA); Rodrigo França, Winnipeg (CA)

(21) Appl. No.: 19/050,666

(22) Filed: Feb. 11, 2025

Related U.S. Application Data
(60) Provisional application No. 63/553,233, filed on Feb. 14, 2024.

(51) Int. Cl. A61C 8/00; A61C 13/00; A61C 13/34

(52) U.S. Cl. CPC A61C 8/0036; A61C 13/0019; A61C 13/34

(57) ABSTRACT

Employment of a lattice structure modelling approach in the design and manufacture of root analogue dental implants enables creation of implants of fully latticed character that maintains load-bearing properties without yielding, while also decreasing stiffness and improving surface design to accelerate bone healing. A novel methodology, that is at least semi-automated, takes into account individual patient data from an initial scan of a patient tooth or tooth root and generates a fully latticed root analogue with optimal mechanical properties and internal and surface features, implemented through additive manufacturing. This denotes innovative advancement over existing approaches to root analogue dental implant, and also offers a solution to dental implantation cases that cannot be resolved by traditional methods.

### CROSS-REFERENCE TO RELATED APPLICATIONS

This application claims benefit under 35 U.S.C. 119(e) of U.S. Provisional Application No. 63/553,233, filed Feb. 14, 2024, the entirety of which is incorporated herein by reference.

### FIELD OF THE INVENTION

The present invention relates generally to the area of dentistry, more specifically to the field of dental implants. Additionally, the invention relates to the field of automated processes for the computer-assisted design and/or the application of additive manufacturing methods for the fabrication and production of patient-specific dental implants.

### BACKGROUND

Dental implants hold pivotal significance in modern dentistry, providing a durable and efficient remedy for various dental conditions. Since their inception for edentulous jaws, they have garnered a reputation as a secure and trustworthy option for replacing missing teeth. In recent years, digital advancements have revolutionized implant dentistry, with the integration of cone beam computed tomography (CBCT) and the advancement of computer-aided design (CAD) techniques. The availability of high-quality CT scans and sophisticated segmentation software has enabled the reverse engineering of dental implants. This empowers the creation of patient-specific root analogue dental implants (RAI) by generating computer models that faithfully replicate anatomical tooth features. To streamline the manufacturing process, direct metal laser sintering, an additive manufacturing technique, can be utilized. This technology directly translates the computer-generated model into a customized implant, offering a faster and more patient-centric alternative to traditional procedures.

Such exploitation of the additive manufacturing process to create patient-specific designs has also been associated with a reduction of overall surgical replacement time [1]. Implants can be designed with various internal structures and pores to achieve certain properties, with the primary goal of reducing the stress shielding problem [2, 3]. Lattice structures, characterized by their porous nature, have the ability to promote a structural and functional integration between the bone and the implant. [4].

Previous studies have shown increasing attempts to improve dental implant survival rates through implant root-analogue design based on CBCT data, implant mechanical properties, and surface and internal structure optimization for specific cases. Dental implantation is one of the most sought-after procedures for patients with tooth loss. The manufacturing of implants has evolved from using metal materials to biocompatible implants made of titanium, which were first introduced to the market in 1978 by Dr. Branemark [5]. He developed a two-stage screw system based on his discovery of the phenomenon of bone firmly bonding to titanium cages used in blood flow experiments. Today, titanium and its alloys are extensively utilized in the fields of orthopedics and dentistry due to their excellent corrosion resistance properties, mechanical strength, and high osteoconductivity properties [6-9]. The integration of digital technology with modern manufacturing options has provided new opportunities for implant design. Additive manufacturing (AM) has been actively used in implant manufacturing for the last 10 years. Initially used for prototyping study models, 3D printing was introduced as a manufacturing technique in the 1990s [10]. The new approach for additive implant manufacturing is direct laser metal sintering (DMLS), which uses a laser to melt metallic powder layer by layer to deposit successive layers.

This manufacturing technique enables the building of a metal root analogue implant based on scans obtained by CBCT of a patient's tooth root anatomy. For example, Figluzzi et al. [11] developed a titanium RAI using CT scans and laser melting technology in 2012. The CT datasets of the fractured tooth were obtained using a modern cone beam scanner, while specialized 3D reconstruction software was utilized to create a representation of the root and assess the alignment between the root and the alveolar socket. The post-processed scan data results were saved as stereolithographic (STL) files, which were subsequently utilized for the manufacturing of the implants using the Direct Laser Metal Sintering (DMLS) technique. DLMS processes for implants use titanium powder Ti-6Al-4V, which is considered the optimal material due to its biocompatibility, corrosion resistance, and ability to withstand mechanical loads. The manufactured RAI was successfully implanted and followed up a year later, with stable results and no signs of infection or issues with peri-implant tissues. In a one-year multicenter study conducted by Mangano et al., the performance of 201 implants manufactured using direct laser metal sintering was evaluated. The study reported exceptionally high survival rates of 99.5% and success rates of 97.5% for the implants [12].

The DLMF process for implants utilizes Ti-6Al-4V titanium powder, which is widely regarded as the ideal material due to its biocompatibility, corrosion resistance, and ability to withstand mechanical loads. In an initial study, the fabricated RAI was implanted successfully, and a one-year follow-up showed stable results with no signs of infection or issues with peri-implant tissues. In a subsequent study by Mangano et al. [13] root-analogue implants manufactured using direct laser metal sintering (DMLS) were placed into the extraction sockets of 15 patients, also yielded excellent results with a 100% survival rate after one year. The high implant survival rate is attributed to the porous structure provided by the DLMF manufacturing process, which promotes primary stability and bone ingrowth as explained by Shibli et al [14]. AM titanium implants have also been shown to be biocompatible and have been physicochemically characterized in previous studies [15, 16]. Several investigations have reported on the surface roughness and mechanical properties that can be achieved by DLMF with titanium AM scaffolds, and regulation of porosity has been shown to be an effective way to achieve the desired mechanical properties in AM implants. Recent research suggests that a minimum level of porosity at 40% is required to achieve mechanical properties comparable to those of human cancellous bone, with Ti-6Al-4V samples exhibiting a maximum compressive strength of 116 MPa and an elastic modulus of 2.5 GPa with ˜66% porosity, as demonstrated by Tan et al. [17].

The compressive properties of bone are known to vary depending on the individual's age and the location within the body. In addition to this, Cheng et al [18] investigated the micro- and nanoscale roughness of DLMF manufactured surfaces and found that their 3D topology may improve the osseointegration of dental implants in vivo. Furthermore, [19] obtained histological evidence of successful osseointegration for a DLMF implant retrieved after five years of function. It is important to note that mechanically obtained primary implant stability is expected to transition into secondary stability once sufficient osseointegration has occurred after healing. The parameters that affect implant post-surgical stability have been debated by researchers such as Miri et al [20], who suggest that biosurfaces and hydrophilic surfaces provide better cell connection.

Several other studies have explored the use of DLMF and RAI implants [21-23], but the broader implementation of RA implants manufactured through DLMF faces several obstacles. One such barrier is the industry's reluctance to adopt new, untested technologies, as their return on investment is often perceived to be low. Another challenged faced is development of a customizable, user-friendly, and highly repeatable protocol for the entire process, from scanning to final RAI manufacturing.

U.S. Pat. No. 11,484,396 by iDentical Inc. of Mountain View, California discloses one proposed methodology, in which a preliminary digital model of an scanned tooth root is modified to remove irregularities of the patient's original tooth root and modify dimensions thereof, including a reduction in exterior volume of disphyseal and apical sections of the tooth root model to accommodate creation of a porous exterior layer of lattice-like structure specifically and solely at these sections impart porosity to an exterior surface of a merged internal core template that is separately responsible to impart the necessary mechanical strength to the RA implant.

Despite such advancement of the art through development of a repeatable modelling procedure for deriving a printable RAI, there remains room for further innovation and improvement in the field of RAI design and production.

### SUMMARY OF THE INVENTION

According to a first aspect of the invention, there is provided an at least semi-automated method of modeling a patient-specific root analogue dental implant, said method comprising:
(a) obtaining a digital 3D model that includes at least a digitally modeled root body representative of a physical root of a patient's scanned tooth root;
(b) using implicit modeling software, applying a stochastic volume lattice function to the digitally modeled root body to impart a lattice throughout a full volume of said root body to achieve a fully-latticed digital root model; and
(c) after finalization of the latticed digital root model, storing a finalized fully-latticed digital root model in computer readable memory as a resource for said additive manufacturing of a root analogue dental implant of fully-latticed character.

Initially, in leadup to the foregoing modeling steps, the patient's tooth, typically characterized by a non-restorable tooth root necessitating replacement thereof with a dental implant, is scanned, either pre- or post-extraction, using a suitable scanning technology, such as Optical Computed Tomography (OCT). The Digital Imaging and Communication in Medicine (DICOM) files derived from the OCT scan are then converted to a 3D imaging file.

As part of the finalization thereof of the latticed digital root model, characteristics thereof can be tailored in a manner motivated by different criteria for the manufactured root analogue dental implant, for instance, ease the insertion of the manufactured root analogue dental implant, stress alleviation on the bone surrounding the alveolar socket during such insertion, and/or enhancement of the connection between the bone and dental implant following the healing process while the root portion of the dental implant remains within the alveolar socket.

In some instances, the lattice of the latticed digital root model, and that of the resulting root analogue dental implant manufactured therefrom, may be characterized by varying lattice density among two or more different regions of the lattice, for example characterized by greater lattice density at an interior region than at one or more outer regions outside the interior region. Such greater density may be beneficial, for example at a location where a dental abutment is to be placed on the root analogue dental implant once healed.

In some instances, adjustments may be made to the size and shape of a root section of the digitally modeled root body, as part of the finalization thereof, relative to the patient's scanned tooth root. This could involve, for instance, an increase or decrease in cross-sectional diameter, in any direction, for example by up to 10% of the digitally modeled root body's original diameter (i.e. diameter of the patient's scanned root body, or the “scanned diameter” for short). This adjustment is to improve initial stability of the manufactured root analogue dental implant after the implantation thereof. For example, such increase or decrease in diameter may be imparted in buccal-lingual direction, whether at the buccal side of the digitally modeled root body, lingual side thereof, or both.

On occasion, adjustments may be made to the size and shape of a coronal section of the digitally modeled root body relative to the original coronal size and shape of the digitally modeled root body (i.e. the scanned coronal size and shape of the patient's scanned tooth root). This could involve, for instance, a decrease in cross-sectional diameter of up to 10% of the original scanned diameter, for example in the buccal-lingual direction, again whether at the buccal side of the digitally modeled root body, the lingual side thereof, or both. This adjustment can mitigate stress concentration on the manufactured root analogue dental implant buccal and lingual directions when implanted. The buccal-lingual reduction in cross-sectional diameter may taper gradually, follow a linear progression, or occur more abruptly, depending on the specific bone morphology into which the manufactured root analogue dental implant is being implanted.

Unlike the prior art patent cited above, the lattice structure in the present invention embodies the full volume of the digitally modelled root body and manufactured root analogue dental implant, whose composition throughout is essentially a porous scaffold, which scaffold not only defines the bone integration interface of the root analogue dental implant, but also defines, in entirety, the mechanical load bearing capability of the root analogue dental implant. to the fully latticed character of the root analogue dental implant thus mitigates stress shielding effects while also promoting better integration with bone tissue.

The volume latticing function of the implicit modelling software generates such porous scaffolding by incorporating voided regions (pores) into the initial volume of the digitally modeled root body, allowing for the establishment of preferred texture during polyhedral expansion. This approach results in a change or adjustment in the orientation of struts within the implant, The degree of anisotropy, or directional dependency, was assessed using mean-intercept length and star volume distribution measurements to evaluate the similarity to trabecular orientation. This is considered to be an effective technique for producing biomimetic porous scaffolds with increased anisotropy and customizable strut architecture in three dimensions, offering a viable alternative to patient-specific bone geometries.

In order to ensure proper adhesion of osteoblasts, implants need to have rough surfaces. In order to achieve optimal biocompatibility, these structures must take into account both geometric features and mechanical performance. The final root analogue dental implant is characterized throughout by a sponge-like lattice structure that achieves necessary mechanical properties of the root, which may be proactively confirmed by simulation performed on the finalized digitally modeled root body using Finite Element Analysis (FEA). Mechanical strength of the root analogue dental implant is analyzed based on typical anticipated forces based on a specific tooth type—i.e. anterior, molar, premolar—of the patient's tooth that the root analogue implant will replace.

The lattice provides a three-dimensional environment that supports cell growth and tissue formation, facilitating efficient diffusion of nutrients and waste products. Lattice can closely match the mechanical properties of natural tissues, making them an ideal candidate for creating customized and biomimetic scaffolds. In preferred embodiments, the average pore diameter, throughout the full volume of the digitally modeled root body and manufactured root analogue dental implant, resides within the range of 100 to 600 microns, and more preferably, within the range of 300 to 600 microns. Any range recited herein is an inclusive range, which includes the upper and lower limits thereof, unless indicated otherwise. The lattice may be characterized as consisting of pores and struts, of which the struts refer to the strands of intact material around the empty pores or voids. Strut radius r, denoting half the diameter or thickness of a lattice strut, measured in millimeters, is related to porosity P of the lattice in the equation P=1.16−0.13×e(r/1.09) In preferred embodiments, the porosity P of the lattice is within the range of 40% to 80%. Beam thickness and pore size are two parameters that can be modified within given limits to enable the quick and effortless modification of the lattice to enable optimization different performance metrics of the root analogue dental implant.

According to a second aspect of the invention, there is provided a root analog dental implant comprising an implant body possessing a latticed character throughout a full volume thereof.

In some embodiments, the root portions of a root-analogue dental implant may include a plurality of connected struts to the degree of forming a less porous or denser structure.

### DESCRIPTION OF THE DRAWINGS

Preferred embodiments of the invention will now be described in conjunction with the accompanying drawings in which:

FIG. 1A is a block diagram depicting a workflow implementation usable for the digital modeling and physical production, via additive manufacturing, of a fully latticed root analogue dental implant, in accordance with preferred embodiments of the current invention.

FIG. 1B is a block diagram depicting a representative processor-based computing system capable of storing data and executing instructions for performing the processes outlined in this document.

FIG. 2 shows CT-scan images of four teeth obtained from the initial scanning stage of the FIG. 1 workflow.

FIG. 3 illustrates initial three-dimensional digital models of the four scanned teeth of FIG. 2, before full-volume latticization thereof in accordance with the present invention.

FIGS. 4A and 4B are flowcharts illustrating execution steps preferably included in the 3D modeling stage of the FIG. 1 workflow.

FIG. 5 illustrates a finalized fully-latticed digital root model derived from the flowcharted execution steps of FIGS. 4A and 4B.

FIGS. 6A through 6D illustrates four finalized fully-latticed digital root models derived from the four initial three-dimensional digital models of FIG. 2 using the flowcharted execution steps of FIGS. 4A and 4B.

FIG. 7 illustrates an initial step in the latticization of the initial three-dimensional digital model, where a volume thereof is populated with random points to serve as seed points for the lattice.

FIG. 8 illustrates a subsequent step in which the struts of the applied lattice are thickened.

FIG. 9 illustrates a finalized digitally modeled fully latticed root body, after uniformity enhancement and trimming of the thickened lattice.

FIG. 10 shows a micro-CT scan from a first group of test implants produced in accordance with the methodology of the present invention.

FIG. 11 shows a micro-CT scan from a second group of test implants produced in accordance with the methodology of the present invention.

FIG. 12 shows a micro-CT scan from a third group of test implants produced in accordance with the methodology of the present invention.

FIG. 13A shows axial and sagittal sections of an implant from the third group of the test implants.

FIG. 13B shows a coronal section and surface view of the implant of FIG. 14A.

FIG. 14 illustrates a finalized digitally modeled fully latticed root body from which one of the tested implants was produced.

FIG. 15 shows the second group of test implants having a Ti-6Al-4V titanium alloy composition and fabricated by direct laser metal sintering.

FIG. 16 shows an experimental setup used for mechanical compression testing of the tested implants.

FIG. 17 is a schematic representation of the mechanical compression test setup of FIG. 17.

FIG. 18 shows measured displacement values for the three groups of tested implants.

### DETAILED DESCRIPTION

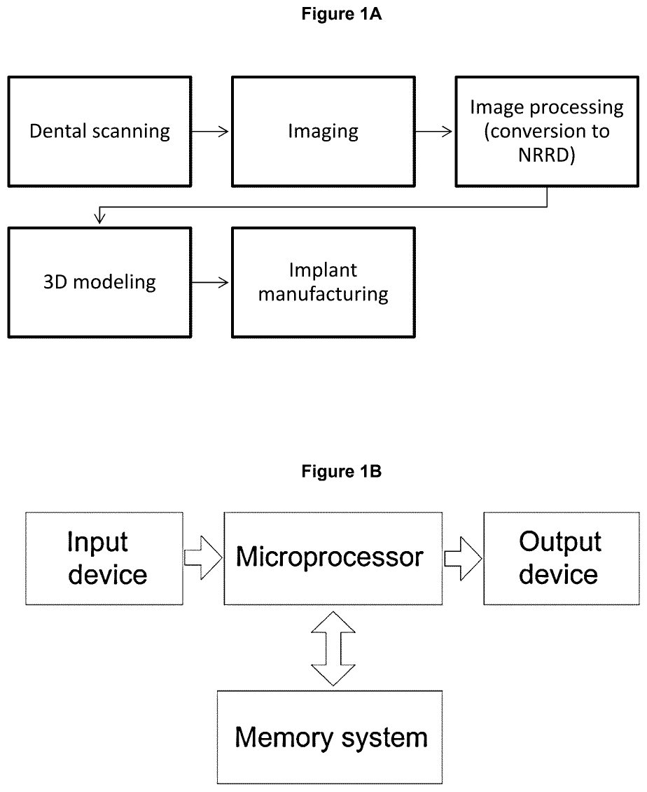

FIG. 1A schematically illustrates the overall methodological workflow for obtaining a root analogue dental implant from a patient's existing tooth, and more particularly a fully latticed root analogue of three-dimensionally latticed character throughout its entire volume, unlike the solid-core surface-lattice dental implant proposed in the cited prior patent referenced above. At the first block of FIG. 1, analogue initial input to the methodology can be obtained by utilizing a three-dimensional scan, a CT scan, an intra-oral scan, or other i imaging technology to capture digital imagery of the patient's tooth root, whether such imaging of the patient's tooth be performed prior to extraction or post-extraction, and whether the input imagery be an image of the entirety of the patient's tooth, or just the root thereof, since it is only the latter of which that the present invention aims to create an implantable patient-specific analogue. The imaging equipment will typically be embodied by the combination of a scanning device that scans the tooth or root, and an imaging device on which a resultant observable image is displayed to the operator of the scanning device. In one non-limiting example, representative of experimental work by the present inventors, a non-restorable tooth, or at least the root thereof, may be scanned post-extraction using Optical Computed Tomography (OCT), and the scan data stored in non-transitory computer readable memory as one or more DICOM (Digital Imaging and Communication in Medicine) files, which file(s) can then converted to a 3D imaging file, for example a using known DICOM software “Slicer 3D” in the same manner as it has been performed by Koppunur, R., et al [24]. In the inventors' work, the scan data was converted to nearly raw raster data (NRRD) format, an anonymized 3D imaging file void of any personal patient information, an then in turn, which in turn, was then converted to STL (Standard Tessellation Language, or Stereolithography) format, embodying a digital model of the scanned tooth or root as surface mesh data.

Such STL format is compatible input for the nTopology or other implicit modeling software used in the modelling stage of FIG. 1A in the inventors' work, but the particular digital model file format used as input to the modeling software, and the particular modeling software itself, may vary in other workable implementations of the present invention. The nTopology engineering design software possesses parametric capabilities and encompasses a range of features including topology optimization, cellular structures, and conformal patterns. These capabilities allowed for the creation of designs that could be easily modified by adjusting parameters, enabling efficient exploration of design variations and optimization. With the software's ability to generate complex and intricate geometries, it provides engineers and designers with powerful tools to enhance the performance and functionality of their designs. FIG. 1B shows a very basic block diagram of a computing system, of which one or more may be employed in execution of the inventive methodology disclosed herein, and at minimum each including one or more processors and non-volatile computer readable memory operatively coupled thereto to enable execution, by said processor(s), of statements and instructions stored in said computer readable memory. Among such executable statements and instructions stored in one or more computer readable memories of one or more computing systems, there is embodiment at least the modeling software by which the initially inputted digital model of the patient's tooth or tooth root converted into a fully latticized digital root model, from which a physical root analogue dental implant can be produced via additive manufacturing. In practice, the scanning equipment will typically embody a computing system separate of that on which the 3D modeling software is run, though this need not always be the case. Communication of files between the computing system of the scanning equipment and that of the 3D modeling environment may involve transport and exchange of portable physical media between locations, purely electronic communication therebetween via one or more communication networks, or some combination thereof via one or more waypoints.

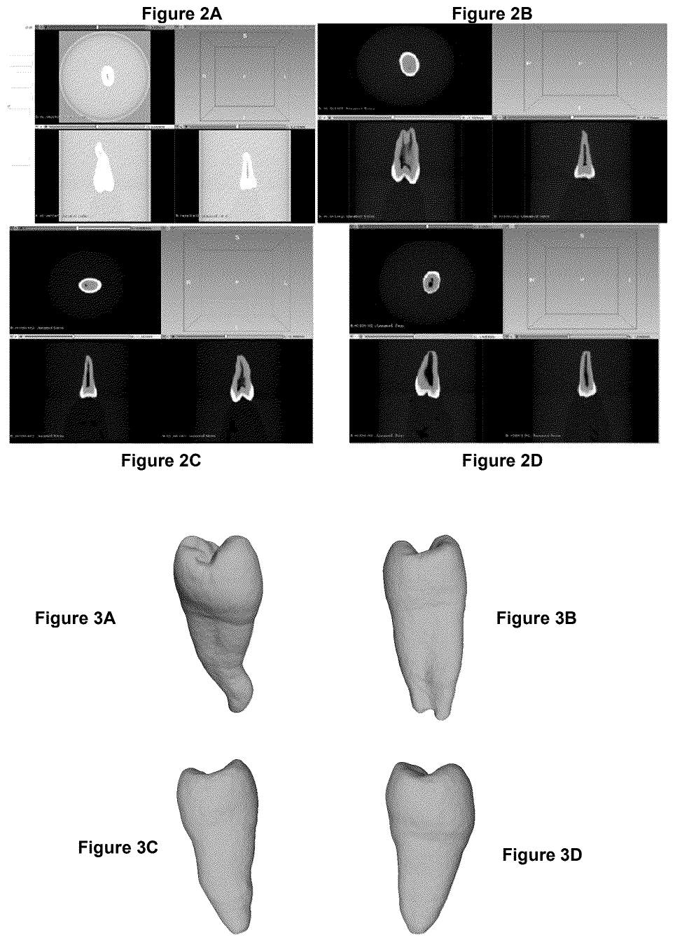

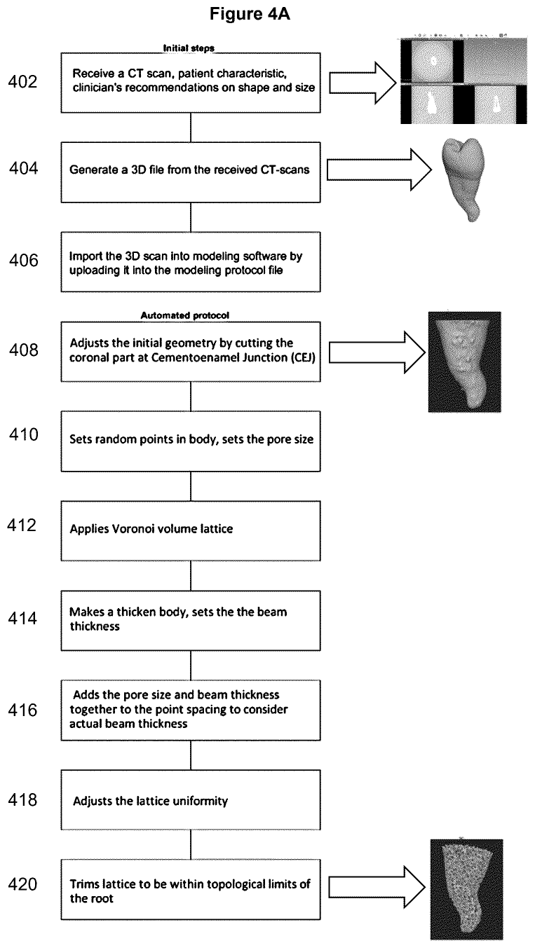

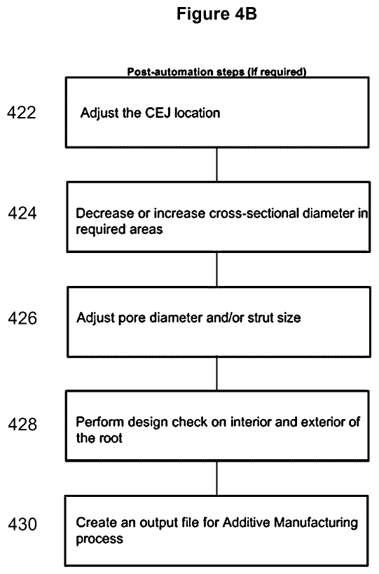

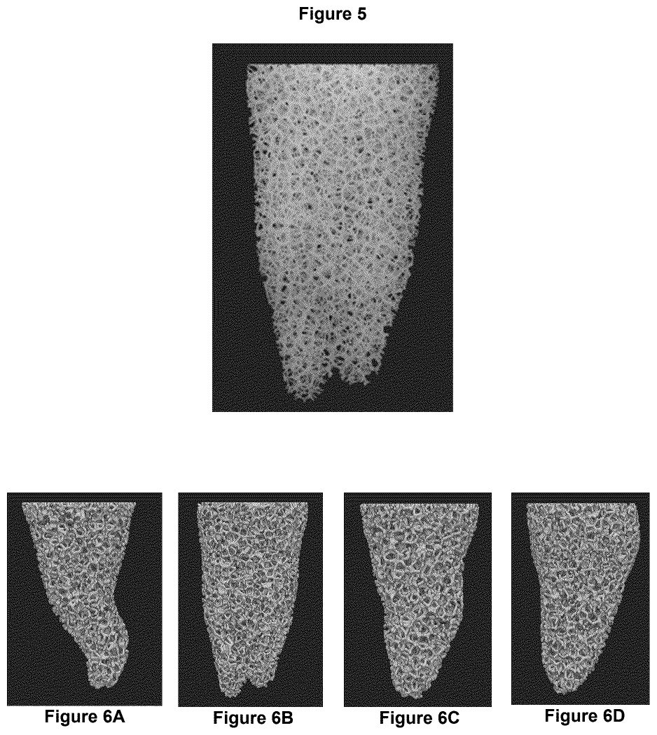

FIG. 2 illustrates scanned images of four different patient teeth that were scanned and modeled in the inventors' work, and FIG. 3 illustrates the four initial three-dimensional models converted from the scanned images, prior to any modification thereof with the modeling software. FIGS. 4A and 4B elaborate on the methodology employed at the image processing and 3D modeling n stages of FIG. 1A, starting at step 402 where the original scan data is received, optionally together with accompanying professional input data embodying, for example, a clinician's recommendations on finished shape and size of the root analogue dental implant to be modeled and produced. Next, at step 404, an initial 3D digital model of the patient's tooth or tooth root is derived from the scan data, for example via indirect conversion therefrom through an intermediary conversion of the scan data first to a 3D imaging format (e.g. NRRD) and then to a digital model format (e.g. STL) compatible with the modeling software. In the event that the modeling software is equipped with its own conversion tools, then intermediary conversion via separate conversion software may be omitted. Accordingly, anywhere reference is made herein to different software applications (conversion software, modeling software, printing software) executing different steps or stages of the overall process shown in FIG. 1, equivalent implementation may instead be accomplished by respective parts modules of a singular software application embodying the capabilities of those separate software applications. Next, at step 406, the digital model is loaded in the modeling software as a starting point from which to derive a fully-attached digital root model from which to produce a root analogue dental implant.

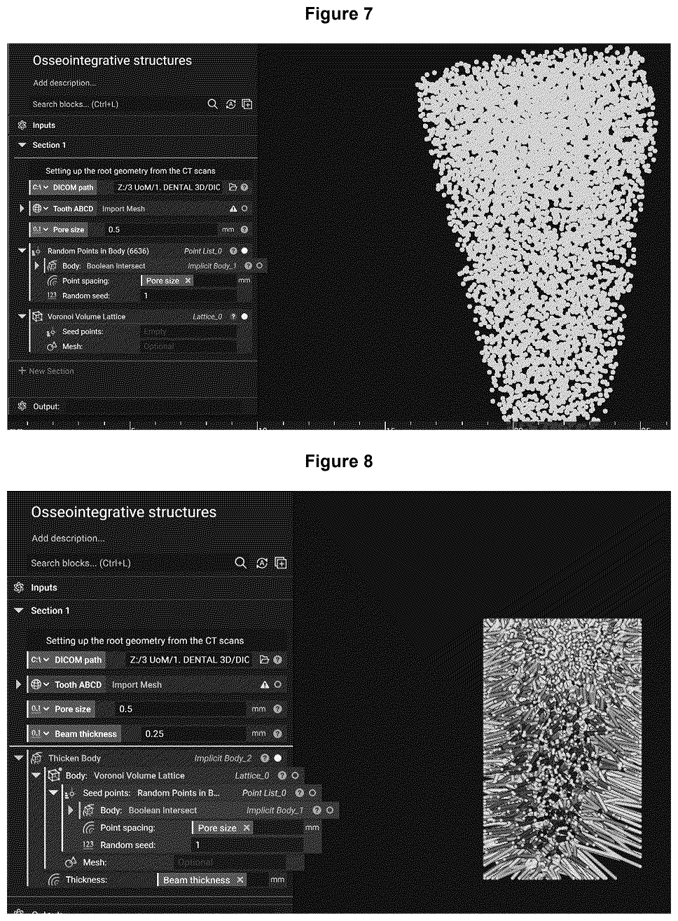

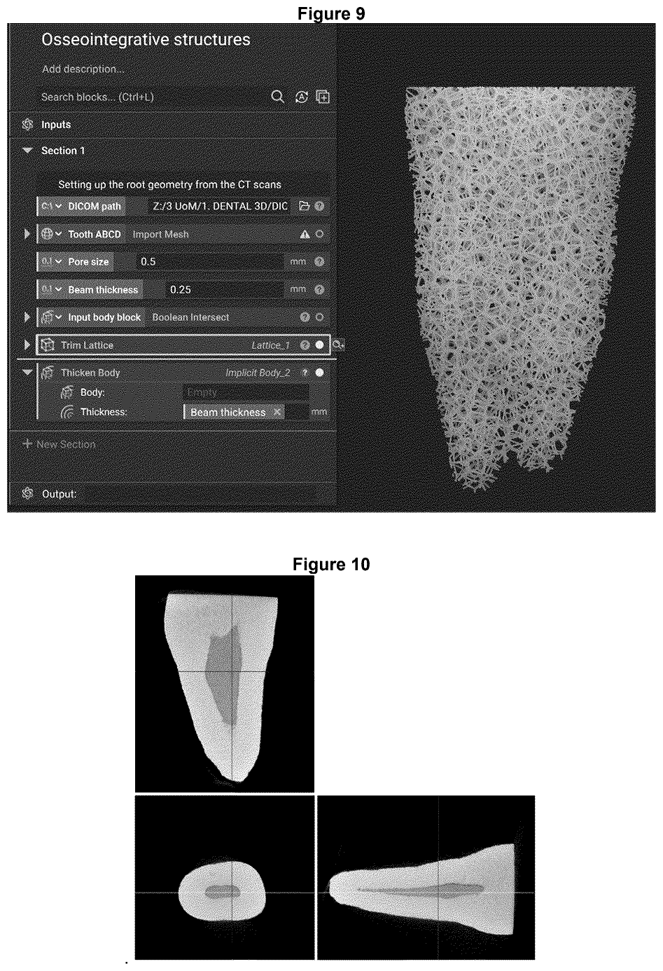

Next, at step 408, in instances where the digital model embodies the patient's entire tooth, or any more than the isolated root thereof, the lower part of digitally modeled tooth body is cut at the Cementoenamel Junction (CEJ) and truncated thereabove to leave behind only the lower root section, which will further modified to digitally model the root-analogue implant. In the nTopology software used in the inventors' work, this isolation of the root was performed by way of a boolean-intersect block to remove the upper non-root section of the modeled tooth body. The digitally modeled and now isolated root body is transformed by the modelling software into an implicit geometry, which enables more efficient latticization thereof, starting at step 410 where the volume of the digitally modeled root body is first populated with random points to serve as seed points for the lattice, for example with a point spacing variable set within the range of 100 to 600 microns in some embodiments, and within the range of 300 to 600 microns in other embodiments, which spacing equates corresponds to optimal pore sizes for implantation of latticed implant bodies. Such population of the digitally modeled root body with random points is shown in FIG. 7.

At step 412, a volume lattice function is then applied to the digitally modeled root body to impart a stochastic latticed structure throughout the full volume thereof. In the inventors' work, a Voronoi lattice was applied, but other lattice types may also be of suitable character for dental implantation, for example a Triply Periodic Minimal Surface (TPMS) lattice. One of the advantages of Voronoi lattices is their ability to closely match the mechanical properties of natural tissues, making them an ideal candidate for creating customized and biomimetic scaffolds. Furthermore, Voronoi lattices provide a three-dimensional environment that supports cell growth and tissue formation, facilitating efficient diffusion of nutrients and waste products. Voronoi lattices offer a compatible environment for cell growth and tissue formation, potentially overcoming the challenge of designing and manufacturing implants with rough surfaces to enable proper osteoblast adherence. Hence, Voronoi lattices hold great promise for bone tissue engineering and regenerative medicine, offering a potential solution to the challenges of developing biocompatible dental implants [25-28].

At step 414, a strut thickness of the lattice may be modified, typically example thickened to an increased diameter, for example to a strut thickness of 0.25 mm in the case of inventor's experimental work, using the “thicken body” function of the nTopology software. The thickening function, by increasing the strut thickness, inherently reduces the pore size of the lattice, and so in the inventors' work, the point spacing variable for the initial lattice function was set near the high end of the optimal pore size range (500 microns), with realization that increasing of the strut thickness after initial latticization would later decrease the pore size. At step 416 the protocol interlinks pore size and strut size and adjusts the lattice to maintain the given pore size and strut radius values.

FIG. 7 illustrates the thickened lattice, which can be seen to have outward spikes of protrusive relation from the exterior of the digitally modeled root body's volume, which spikes at the outer boundaries of the root body's volume deviate from a desired lattice uniformity, which is corrected at step 418. Here, the volume of the lattice is increased, for example using the offset function of the nTopology software, so that the non-uniformities or distortions of the lattice at outer regions thereof will now reside outside the original root body's volume, whereafter the lattice is then trimmed down to that original root body's volume at step 420, thereby removing the distortions or non-uniformities from the latticed digitally modeled root body. In initial experimentation by the inventors, steps 408 to 420 were programmed via human operator input to the n-Topology modeling software. However, in practical application of the novel methodology, steps 408 to 420 perform automatically after uploading any scan file.

FIG. 4B illustrates optional modification steps 422 to 428 that may supplement steps 402 to 420 of FIG. 4A, in lead up to creating and saving a final output file usable by printing software of an additive manufacturing setup to print a physical full-latticed root analogue dental implant embodying the finalized design of the fully latticed digitally modeled root body, which may also be saved in a separate file of a different format other than the final output file for the additive manufacturing process, for example in instances where the modelling software and the printing software differ in their respective file formats. Steps 422 to 428, or any subset thereof, may be implemented by a human operator interfacing with the modeling software, if adjustment to the automated steps 402 to 420 of FIG. 4A is required, though partial or full automation of the FIG. 4B modification steps may also be possible. The options modification steps may include any one or more of adjustment of the CEJ location of the digitally modeled root body, per illustrated step 422; increase or decrease of the cross-sectional diameter, in mesial-distal and/or buccal-lingual directions, at any selected areas of the digitally modeled root body, per illustrated step 424; adjustment of pore size and/or strut thickness, per illustrated step 424; and/or performance of a design check of the interior and exterior of the digitally modeled root body, per illustrated step 428. This may include, but not limited to the visual topology and lattice inspection, measurement of specific cross-section of the latticed body and comparison with the initial scan dimensions of the same cross-section as well as visual inspection of any lattice abnormalities-vacancies, dislocations etc. Once the final output file, for example if Additive Manufacturing File (AMF) format, is created at step 430 as usable input to an additive manufacturing process, a root analogue dental implant of fully latticed character throughout its entire volume can be printed and post-processed at the final manufacturing stage of the FIG. 1 workflow, followed by implantation thereof in the patient by a dental practitioner.

In brief summary of the detailed embodiment set forth above in relation to the appended figures, the process of designing an implant may involve using a three-dimensional scan or other images and data of the extracted tooth root as a foundation for creating a three-dimensional model of a dental implant, which will serve as a replacement for the removed tooth. This implant can then be produced by additive manufacturing method. Following production, a root-analogue dental implant created through one or more of the processes can be immediately placed into the alveolar socket from which the scanned and/or imaged tooth or tooth root was extracted. Digital scans of the non-restorable tooth, typically obtained at a dental clinic will be electronically submitted to an typically separate digital processing facility, for the protocol implementation and controls, with the additive manufacturing then being performed at the same processing facility, or a separate manufacturing facility, again typically separate of the dental clinic. In scenarios where the patient's tooth or tooth root was scanned prior to extraction in an initial scanning appointment, a later extraction and implantation appointment, optionally at the same dental clinic, takes place after manufacture of the root analogue implant, which can therefore be immediately placed after the extraction in this later extraction appointment. The jawbone naturally adapts to the implant, filling the vacated alveolar socket. The presently disclosed methodology enables the creation of patient-specific designs and reduces overall surgical replacement time compared to conventional dental implant practice.

Implants can be designed with various internal structures and pores to achieve certain properties, with the primary goal of reducing the stress shielding problem. Stress-shielding effects arise from shear stresses due to the difference of material properties between bone and the implant. Lattice structures, distinguished by their inherent porosity, play a crucial role in enabling the controlled adjustment of elastic modulus, which in turn facilitates the integration of bone and implant on both structural and functional levels. Three-dimensional (3D) planning/computer-aided design (CAD) and manufacturing have evolved to the point where implant properties could be pre-set to achieve early osseointegration and eliminate the mechanical shielding effect, a common complication often leading to implant loss.

Regarding material selection for the root analogue dental implant, titanium and its alloys are extensively utilized in the fields of orthopedics and dentistry due to their excellent corrosion resistance properties, mechanical strength, and high osteoconductivity properties. One available approach for additive implant manufacturing is direct laser metal sintering (DMLS), which uses a laser to melt metallic powder layer by layer to deposit (print) successive layers. Porous Ti-6Al-4 V constructs with surface roughness and bio-inspired porosity have shown enhanced cell response and mineralization in vitro with newly formed bone contact reported to be primarily composed of woven bone connecting the peri-implant bony trabeculae to the micro-implant surface. Another advantage of additively manufactured dental implants is the sufficient precision of the method that could be used to manufacture implants of any desired shape and size. The digital workflow allows working with the implant and prosthetic crown or denture before the implantation, offering surface topography that could not be created by available manufacturing techniques nowadays.

Titanium additively manufactured implants are suitable for immediate implantation. The advantages of immediate implantation include reduced rehabilitation time and no need for a second surgical procedure. One of the advantages of the presently disclosed methodology is that multiple parameters can be tailored to achieve desired mechanical and biological properties. These parameters are controlled through pores size, shape, distribution, interconnectivity, and percentage of porosity. Pore size and percentage of porosity play an important role in the mechanical properties and the porous implant can greatly decrease the shearing stress exerted on the bone during mechanical loads.

The inventive methodology of the present application preferably automates at least part of the complex process of designing and manufacturing the implant. The efficacy of bone implants with porous scaffolds depends heavily on the geometric structure of metallic scaffolds. The incorporation of porosity in implant designs has been recognized to mitigate stress shielding effects and promote better integration with bone tissue. The inventive methodology offers a novel method to automate, or at least simplify, at least part of the modelling for such structures by incorporating voided regions within the initial volume, allowing for the establishment of preferred texture during polyhedral expansion. This approach results in a change or adjustment in the orientation of struts within the implant. The inventive methodology represents an effective technique for producing biomimetic porous scaffolds with increased anisotropy and customizable strut and pore size, offering a viable alternative to patient-specific bone geometries.

To achieve the desired mechanical strength and osseointegration properties of the root analogue dental implant, the pore size and strut thickness parameters of the digital model can be fine-tuned, preferably within at least one of the optimal ranges disclosed herein, to achieve the best results. To such end, the inventive method may include finite element analysis (FEA) conducted on the finalized fully latticed digital root body, after step 420, and after any optionally included subsequent steps 422 to 428, to confirm its mechanical strength, ensuring that it meets the required specifications for successful implantation. This analysis simulates the implant under various loading conditions to verifying that it can withstand the stresses and strains imposed on it during everyday use.

3D printed root analogue implants were produced in accordance with the inventive methodology disclosed herein, and subjected to testing, including CT scanning and mechanical evaluation. The tested implants exhibited excellent structural integrity, showing no signs of distortions, cracking, or oxide layers on their surfaces. A sufficient amount of material found to be present between adjacent porous channels in perpendicular planes leads to confident prediction that the implants could effectively prevent failure. Samples successfully withstood applied load with no visible alterations in their length, among which samples were included porous ones, and there were found to be no noticeable distortions around the porous channels.

Eighteen porous metal prototypes were fabricated at the end of 2023, in three groups possessing the following characteristics:

TABLE 1
Pore size, Strut Diameter and number of manufactured samples

| | | | RAI (Root |
|---|---|---|---|
| | | | Analog |
| | | | Implant) |
| Group | Pore size, μm | Strut Diameter, μm | manufactured |
| 1 | 100 | 150 | 6 |
| 2 | 200 | 250 | 6 |
| 3 | 300 | 250 | 6 |

Non-destructive imaging for structural integrity was evaluated using a micro-CT scan for three samples in each group. The stiffness of the fabricated RAIs (n=3 for each Group) was evaluated using uniaxial mechanical testing. The micro-CT assessment underscores the significance of pore connectivity and size in facilitating bone ingrowth, which is essential for both angiogenesis and osteogenesis. Despite current limitations in achieving porosity below 30%, implants with optimized pore structures can promote stable osseointegration compared to solid implants.

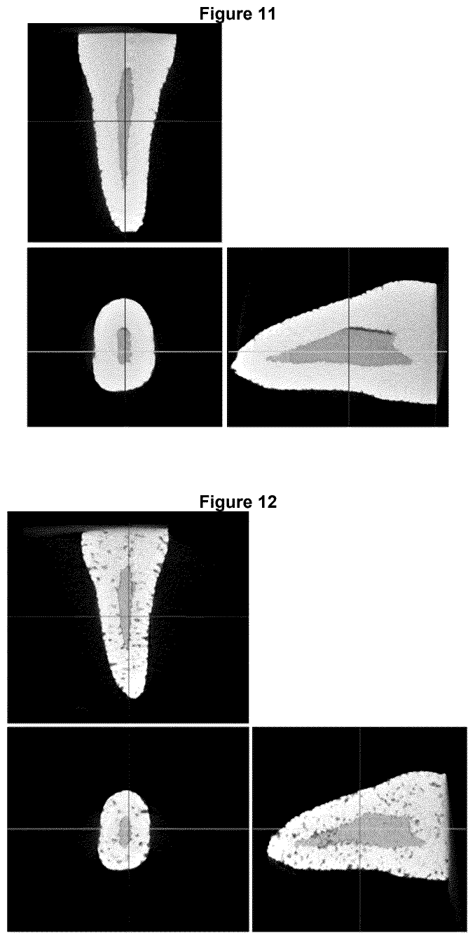

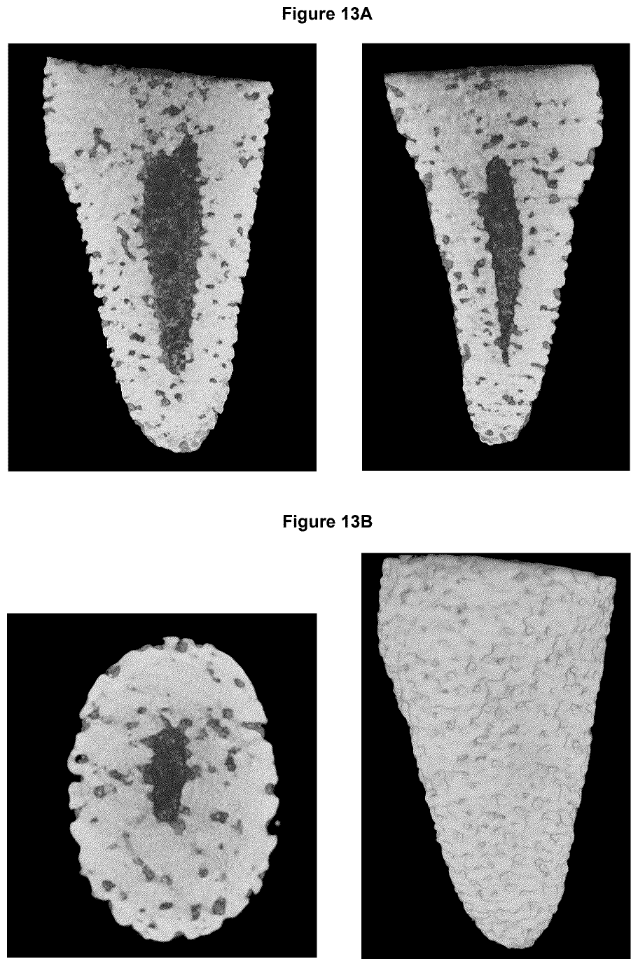

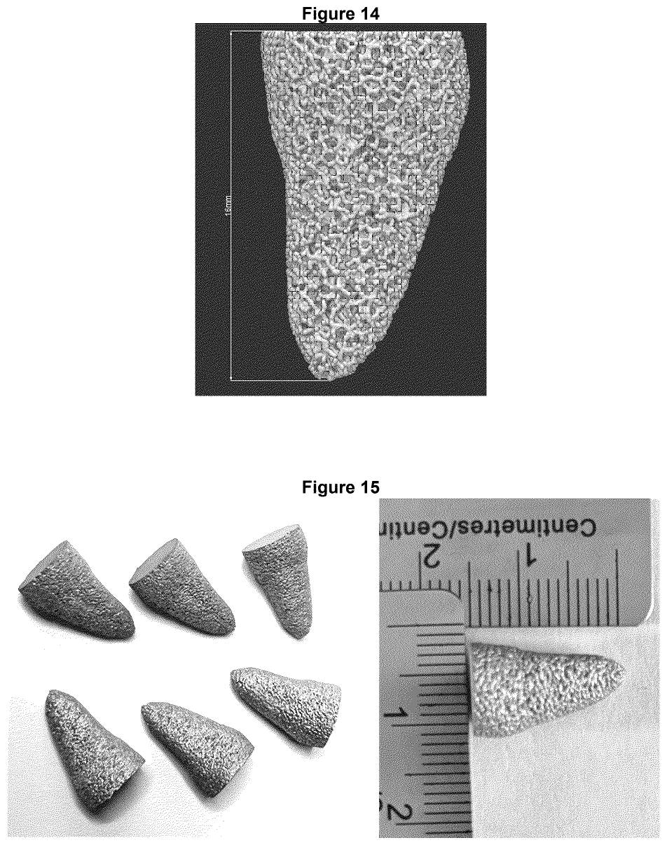

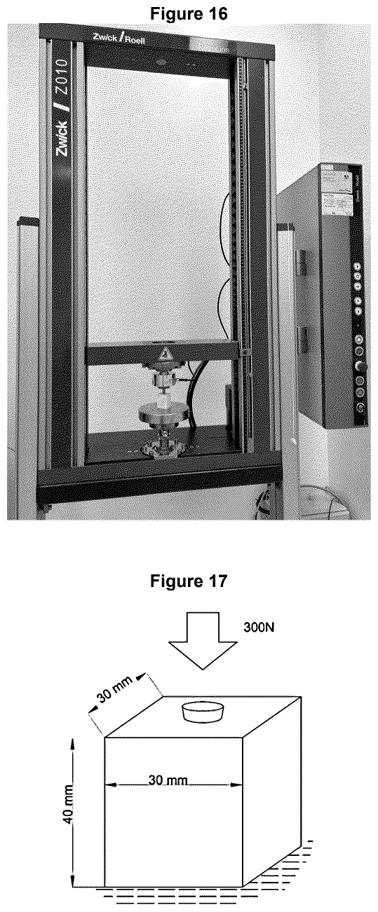

Micro-CT scanning of the RAIs revealed that the porous structure is present in sample Group 3, with a pore size of 300 μm and a strut diameter of 250 μm. Groups 1 and 2 with 100μ and 200μ pore sizes have no interconnected pores although Group 2 RAI exhibit some porosity (FIGS. 10-12). SEM images also revealed the presence of solidified Ti-6Al-4V particles and residual particles in the internal part of the RAI. The average pore sizes measured at 10 random locations along the cross section of the Group 3 porous implant from μ-CT images were 231.232±60.581 μm. Axial, sagittal, and coronal views of the Group 3 sample RAI as well as the surface picture are presented in FIG. 13.

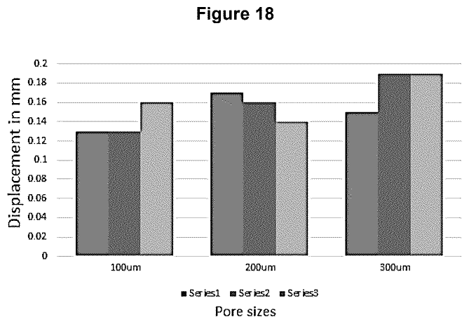

When subjected to a 300 N compressive load applied along the vertical axis, the RAIs (n=3 for each group) exhibited an average maximum deformation of 0.14±0.017 mm for Group 1, 0.16±0.015 mm for Group 2, and 0.18±0.023 mm for Group 3. After removing the load from implants, there were no visible alterations in their length, including the porous ones, and there were no noticeable distortions around the porous channels for Group 3 samples. This observation remained consistent across all tested implants. FIG. 18 demonstrates the displacement values obtained from the experiments on 3 groups of samples. Future work is contemplated to address and mitigate stress concentration between the porous channels of the porous layer to guarantee the long-term success of an implant.

Since various modifications can be made in the invention as herein above described, and many apparently widely different embodiments of same made, it is intended that all matter contained in the accompanying specification shall be interpreted as illustrative only and not in a limiting sense.

### REFERENCES

ADDIN EN.REFLIST 1. Gattinger, J., C. N. Bullemer, and O. L. A. Harrysson, Patient specific root-analogue dental implants—Additive manufacturing and finite element analysis. Current Directions in Biomedical Engineering, 2016. 2(1): p. 101-104.
2. Sola, A. and A. Nouri, Microstructural porosity in additive manufacturing: The formation and detection of pores in metal parts fabricated by powder bed fusion. Journal of Advanced Manufacturing and Processing, 2019. 1(3).
3. Du, Y., et al., Design and statistical analysis of irregular porous scaffolds for orthopedic reconstruction based on voronoi tessellation and fabricated via selective laser melting (SLM). Materials Chemistry and Physics, 2020. 239.
4. Marinela Peto, E. R.-C., Mohammad J. Uddin, Ciro A. Rodriguez, Hector R. Siller, Mechanical Behavior of Lattice Structures Fabricated by Direct Light Processing With Compression Testing and Size Optimization of Unit Cells, in International Mechanical Engineering Congress and Exposition IMECE2019. 2019: Salt Lake City, UT, USA.
5. <A Brief Historical Perspective on Dental Implants, Their Surface Coatings and treatments.pdf>.
6. Dabrowski, B., et al., Highly porous titanium scaffolds for orthopaedic applications. J Biomed Mater Res B Appl Biomater, 2010. 95(1): p. 53-61.
7. Elias, C. N., et al., Mechanical properties, surface morphology and stability of a modified commercially pure high strength titanium alloy for dental implants. Dent Mater, 2015. 31(2): p. e1-e13.
8. Ferraris, S., et al., Micro- and nano-textured, hydrophilic and bioactive titanium dental implants. Surface and Coatings Technology, 2015. 276: p. 374-383.
9. Wally, Z., et al., Porous Titanium for Dental Implant Applications. Metals, 2015. 5(4): p. 1902-1920.
10. Dawood, A., et al., 3D printing in dentistry. Br Dent J, 2015. 219(11): p. 521-9.
11. Figliuzzi, M., F. Mangano, and C. Mangano, A novel root analogue dental implant using CT scan and CAD/CAM: selective laser melting technology. Int J Oral Maxillofac Surg, 2012. 41(7): p. 858-62.
12. Mangano, C., et al., Prospective clinical evaluation of 201 direct laser metal forming implants: results from a 1-year multicenter study. Lasers Med Sci, 2012. 27(1): p. 181-9.
13. Mangano, F. G., et al., Immediate, non-submerged, root-analogue direct laser metal sintering (DLMS) implants: a 1-year prospective study on 15 patients. Lasers Med Sci, 2014. 29(4): p. 1321-8.
14. Shibli, J. A., et al., Bone-to-implant contact around immediately loaded direct laser metal-forming transitional implants in human posterior maxilla. J Periodontol, 2013. 84(6): p. 732-7.
15. Sidambe, A. T., Biocompatibility of Advanced Manufactured Titanium Implants—A Review. Materials (Basel), 2014. 7(12): p. 8168-8188.
16. Fiuza, C., et al., Physicochemical characterization of DMLS dental implants. Dental Materials, 2017. 33: p. e31.
17. Tan, X. P., et al., Metallic powder-bed based 3D printing of cellular scaffolds for orthopaedic implants: A state-of-the-art review on manufacturing, topological design, mechanical properties and biocompatibility. Mater Sci Eng C Mater Biol Appl, 2017. 76: p. 1328-1343.
18. Cheng, A., et al., Laser-Sintered Constructs with Bio-inspired Porosity and Surface Micro/Nano-Roughness Enhance Mesenchymal Stem Cell Differentiation and Matrix Mineralization In Vitro. Calcif Tissue Int, 2016. 99(6): p. 625-637.
19. Mangano, F., et al., Histological Evidence of the Osseointegration of Fractured Direct Metal Laser Sintering Implants Retrieved after 5 Years of Function. Biomed Res Int, 2017. 2017: p. 9732136.
20. Miri, R., et al., <Relationship and changes of primary and secondary stability in dental implants_a review.pdf>. International Journal of Contemporary Dental and Medical Reviews, 2017.
21. Revilla-León, M. and M. Özcan, Additive Manufacturing Technologies Used for 3D Metal Printing in Dentistry. Current Oral Health Reports, 2017. 4(3): p. 201-208.
22. Demirbaş, A. E., et al., Patient-specific Root-analogue Immediate Titanium Premolar Dental Implants: Prospective Evaluation of Fifteen Patients with One-year Follow-up. Meandros Medical and Dental Journal, 2019. 20(2): p. 121-128.
23. Barazanchi, A., et al., Additive Technology: Update on Current Materials and Applications in Dentistry. J Prosthodont, 2017. 26(2): p. 156-163.
24. Koppunur, R., et al., Design and Fabrication of Patient-Specific Implant for Maxillofacial Surgery Using Additive Manufacturing. Advances in Materials Science and Engineering, 2022. 2022: p. 1-7.
25. Deering, J., et al., Selective Voronoi tessellation as a method to design anisotropic and biomimetic implants. J Mech Behav Biomed Mater, 2021. 116: p. 104361.
26. Liang, H., et al., Trabecular-like Ti-6Al-4V scaffolds for orthopedic: fabrication by selective laser melting and in vitro biocompatibility. Journal of Materials Science & Technology, 2019. 35(7): p. 1284-1297.
27. Vafaeefar, M., et al., A morphological, topological and mechanical investigation of gyroid, spinodoid and dual-lattice algorithms as structural models of trabecular bone. J Mech Behav Biomed Mater, 2023. 138: p. 105584.
28. Ruiz, O., et al., Effects of architecture, density and connectivity on the properties of trabecular bone: a two-dimensional, Voronoi cell based model study. 2011. p. 77-89.
29. Yue, X., et al., Additive manufacturing of high porosity magnesium scaffolds with lattice structure and random structure. Materials Science and Engineering: A, 2022. 859.
30. Chang, J. Z. C., et al., Augmentation of DMLS biomimetic dental implants with weight-bearing strut to balance of biologic and mechanical demands: From bench to animal. Materials, 2019. 12(1).
31. Tunchel, S., et al., 3D Printing/Additive Manufacturing Single Titanium Dental Implants: A Prospective Multicenter Study with 3 Years of Follow-Up. International Journal of Dentistry, 2016. 2016: p. 8590971.

1. An at least semi-automated method of modeling a patient-specific root analog dental implant, said method comprising:
(a) obtaining a digital 3D model that includes at least a digitally modeled root body representative of a physical root of a patient's scanned tooth root;
(b) using implicit modeling software, automatically applying a stochastic volume lattice function to the digitally modeled root body to impart a lattice throughout a full volume of said root body to achieve a fully-latticed digital root model; and
(c) after finalization of the latticed digital root model, storing a finalized fully-latticed digital root model in computer readable memory as a resource for said additive manufacturing of a root analog dental implant of fully-latticed character.

2. The method of claim 1 wherein step (b) comprises applying stochastic lattice that mimics bone-like spatial partitioning lattice, or minimal surface lattice, to the digitally modeled root body.

3. The method of claim 1 wherein step (b) comprises, after applying the volume lattice function, thickening a strut diameter of the lattice, effectively implementing a desired pore size thereof.

4. The method of claim 3 comprising, subsequent to said thickening of the lattice, trimming protrusive extremities of the lattice that exceed former topological limits of the digitally modeled root analog implant prior to incorporation of the thickened lattice.

5. The method of claim 4 comprising, after said thickening of the lattice and before said trimming of protrusive extremities of the lattice, enlarging the digitally modeled root body.

6. The method of claim 1 wherein an average pore size of the lattice of the finalized digital root model, throughout a full volume thereof, resides within a range of 100 to 600 microns.

7. The method of claim 6 wherein said average pore size resides, more specifically, within a range of 100 to 300 microns.

8. The method of claim 1 wherein a porosity of the finalized digital root model, throughout a full volume thereof, ranges resides within a range of 40 to 80 percent.

9. The method of claim 1 wherein step (b) comprises imparting varying lattice density among different volumetric regions of the digitally modeled root body.

10. The method of claim 9 comprising imparting a greater lattice density in an interior region of the digitally modeled root body than at one or more exterior regions thereof outside said interior region.

11. The method of claim 1 wherein step (b) further comprises using the latticed digital root model to evaluate anticipated performance, and modifying the latticed character of the latticed digital root model to improve said anticipated performance.

12. The method of claim 11 comprising use of finite element analysis in evaluation of the anticipated performance of the latticed digital root model.

13. The method of claim 1 further comprising (d) producing said physical root analog dental implant of fully-latticed character through additive manufacturing.

14. The method of claim 1 wherein latticization of the digitally modelled root body is at least partially automated, via execution, by one or more processors, of statement and instructions stored in non-transitory computer readable memory.

15. A root analog dental implant produced through additive manufacturing based using the latticed digital root model created in claim 1.

16. A root analog dental implant comprising an implant body possessing a latticed character throughout a full volume thereof.

17. The root analog dental implant of claim 15 wherein the implant comprises stochastic lattice that mimics bone-like spatial partitioning lattice, or minimal surface lattice.

18. The root analog dental implant of claim 17 wherein the latticed character of the implant body is characterized by an average pore size that, through a full volume of implant body, resides within a range of 100 to 600 microns.

19. The root analog dental implant of claim 18 wherein said average pore size resides, more specifically, within a range of 100 to 300 microns.

20. The root analog dental implant of claim 15 having a porosity that, throughout a full volume of the implant body, resides within a range of 40 to 80 percent.

21. The root analog dental implant of claim 15 wherein the implant body has varying lattice density among different volumetric regions of the implant body.

22. The method of claim 21 wherein the implant body has a greater lattice density in an interior region of the implant body than at one or more exterior regions thereof outside said interior region.
